(19) United States
(12) Patent Application Publication
(10) Pub. No.: US 2011/0293683 A1
(43) Pub. Date: Dec. 1, 2011

(54) Silver antimicrobial composition with extended shelf-life

(75) Inventor: Albert Gary DiFrancesco, Rochester, NY (US)

(73) Assignee: Cerion Technology, Inc.

(21) Appl. No.: 13/068,972

(22) Filed: May 25, 2011

Related U.S. Application Data
(60) Provisional application No. 61/348,056, filed on May 25, 2010.

(51) Int. Cl. A01N 25/34; A01N 25/00; A01P 1/00; A01N 59/16

(52) U.S. Cl. 424/411; 424/618; 424/405

(57) ABSTRACT

A method for extending the shelf-life of an aqueous dispersion comprising silver halide particles and gelatin, comprises adding adenine to the aqueous dispersion in an amount effective to improve the redispersibility and the colloidal stability thereafter of the aqueous dispersion following extended storage. The extended storage time consisted of 5 days at a temperature of about 40° C. The gelatin amount ranged from about 4 weight % to less than about 1 weight %. The invention also relates to a method of coating fibers, fabrics or substrates with the improved composition to provide antimicrobial properties, and to the coated articles.

### CROSS-REFERENCE TO RELATED APPLICATIONS

This application claims the benefit of priority from U.S. Provisional Patent Application Ser. No. 61/348,056, SILVER ANTIMICROBIAL COMPOSITION WITH EXTENDED SHELF-LIFE, filed May 25, 2010, in the name of Albert Gary DiFrancesco.

### FIELD OF THE INVENTION

The present invention relates in general to antimicrobial compositions comprising silver halide particles, gelatin, and water. More particularly, the invention relates to a process for improving the redispersibility and the subsequent colloidal stability of an aqueous silver halide particle and gelatin dispersion following extended storage. The invention also relates to a method of coating fibers, fabrics, or substrates with the improved composition to provide antimicrobial properties, and to the coated articles thereof.

### BACKGROUND OF THE INVENTION

The antimicrobial properties of silver have been known for several thousand years. It is now understood that the affinity of silver ion for biologically important chemical moieties such as sulfhydryl, amino, imidazole, carboxyl and phosphate groups is primarily responsible for its antimicrobial activity. This affinity enables silver ion to destroy or inhibit the growth of microorganisms such as bacteria, fungus, yeast, algae, and possibly viruses.

One emerging use of silver based antimicrobial agents is as a coating on textiles for odor prevention. Various methods are known in the art to render antimicrobial properties to a given fiber. In particular, Suga et al., Japanese Patent 2,998,584B2 (JP1996-209531A), describe a method of producing an antimicrobial fiber by adhering a very small amount of antimicrobial fine particles (diameters less than 500 nanometers (nm)), such as silver halide particles, to the surface of the fiber using a polymeric (resin) binder. Durability of an antimicrobial effect after 10 laundry washings is described for silver based antimicrobial coatings on wool and cotton fabrics. Similar results are described by Green et al., U.S. Pat. No. 6,584,668; wherein durable antimicrobial effects are shown for zinc oxide and a variety of silver based antimicrobial agents other than silver halides, adhered wholly, or, at least in part, to fiber containing substrates by use of a polymeric binder. More particularly, this reference reveals treated fiber substrates that retain at least about 50% of the adhered antimicrobial finish after 10 washes.

The use of silver halide as an antimicrobial agent for articles used in medical applications is described in various references. For example, Walder in U.S. Pat. No. 5,848,995 describes an impregnation process wherein pellets of a hydrophilic polymer are contacted with a solution of a soluble silver salt, followed by a solution of a chloride salt to form silver chloride. The impregnated pellets are then melt processed such that silver chloride is distributed throughout the bulk of the polymer matrix. Terry in U.S. Pat. No. 6,716,895 describes antimicrobial formulations comprising a hydrophilic and/or hydrophobic polymer binder, and a mixture of two or more distinct sources of oligodynamic (antimicrobial) metals, such that the aqueous solubilities of the metals differ substantially. In this way both a fast initial release and a slower long-term release of antimicrobial metal ion is provided. Examples are specifically described using silver nitrate, silver lactate and silver acetate as fast silver ion release agents, in combination with silver chloride and silver iodide as slow silver ion release agents.

A major drawback with the practical use of silver halide as an antimicrobial agent relates to the poor colloidal stability of aqueous dispersions (suspensions) of fine particles (less than about 1 micron diameter) of silver halide. Poor colloidal stability results in particle settling due to the relatively high density of silver halide particles. For example, crystalline silver chloride has a density of 5.6. Particle aggregation, alternatively termed agglomeration, coagulation, or flocculation, is a related problem. Settling and aggregation may occur during product shipping or storage, potentially in warm tropical climates or under long-term warehouse storage conditions. The tendency for settling and aggregation can adversely impact the ease of use and practical shelf-life of silver halide particles used as an antimicrobial agent, for example, in fabric treatment applications.

If particle aggregation or agglomeration is substantially irreversible, then redispersal by the end-user may be incomplete. If particle settling is severe, whereby an irreversible cake (bottom layer) is formed, then inefficient or incomplete transfer of the silver halide material from the transport/storage container to the end-users manufacturing equipment (e.g. textile pad bath) can result. This may cause several problems for the end-user. Antimicrobial efficacy may be compromised if the release of silver ions from aggregated particles is thereby inhibited. Uniformity of distribution of silver halide particles across a substrate, such as along a textile fiber or fabric, may also be reduced, resulting in increased cost to the end-user if a greater amount of silver halide is then required to achieve the desired antimicrobial effect. In extreme cases, large clumps of inadequately redispersed silver halide particles may appear as a visual defect that ruins the appearance of fabrics or textile products to which they have been applied. In addition, settling of the silver halide particles in the end-user's manufacturing equipment vessels may lead to further non-uniformity and waste.

Several approaches have been taken in the past to address the problem of colloidal instability of silver halide dispersions. In many traditional silver halide photographic manufacturing operations, colloidal instability is countered by aggressive and continuous mechanical stirring during particle formation (precipitation), and by rapid continuous pumping under high shear conditions to prevent or reduce settling during coating and drying operations. During storage of photographic silver halide dispersions (historically termed photographic “emulsions”), large amounts of gelatin, a natural polypeptide dispersant, are used. The gelatin is typically in the range of 3-10 weight %, such that upon cooling to less than about 35° C., solidification (gelation) of the three-dimensional gelatin polymer network occurs, thereby preventing the settling of the dense silver halide particles. While these methods work well for photographic film fabrication, they are clearly ill suited to deliver aqueous dispersions of silver halide particles to many end-users of antimicrobial compositions.

In one specific attempt to extend shelf-life, Tessier et al. in WO2006/105669 describe the addition of a stoichiometric amount of benzalkonium chloride surfactant during in the preparation of aqueous silver chloride particle dispersions, thereby improving both the colloidal stability during storage and, subsequently, the redispersal thereof after particle settling has occurred. These studies, however, are limited to room temperature storage conditions of 65 hours duration.

In yet another approach, Schroeder et al. in U.S. Patent Application Publication 2006/0068024 describe the use of low amounts of gelatin (less than 1 weight %) to provide antimicrobial aqueous silver halide particle dispersions that do not substantially gel or solidify at 25° C. These free flowing dispersions are easily transferred and mixed with aqueous diluents or other chemical addenda typically used in a yarn or textile coating operation.

Sandford et al. in U.S. Patent Application Publication 2010/0047321 disclose, however, that after a short-term (5 day) unstirred storage and redispersal thereafter, aqueous silver chloride particle dispersions containing a low amount of gelatin (0.16-0.62 wt. %) suffer from severe particle settling. In attempts to address this severe post storage/redispersal colloidal instability, these researchers describe the effect of addition of a wide variety of compounds as potential post storage/redispersal dispersion stabilizers, including organic acids, surfactants, sugars and inorganic salts. Among these additives are many compounds well known within the photographic chemistry art to interact (i.e. chemisorb or physisorb) with silver halide grain surfaces (i.e. common photographic addenda), for purposes other than post-storage redispersibility and dispersion stability thereof. These photographic addenda include, for example, acetamidophenylmercatotetrazole (APMT), tetraazaindene (TAI), bromo-tetraazaindene (Br-TAI), 2-methylthio-tetraazaindene (SMe-TAI), methyl-1H-benzotriazole (Me-BZT), 6-chloro-4-nitro-1H-benzotriazole (CN-BZT), tetraethyl ammonium chloride, ammonium nitrate, and ammonium sulfate. These researchers report, however, that N-heterocyclic acids that improve the post-storage redispersibility and dispersion stability thereafter, are limited to those with acidity in the specific range of pKₐ from 4.8 to 8.0.

Thus, to date, while there have been some improvements in achieving a more complete redispersal and improved colloidal stability thereafter of aqueous dispersions of preformed silver halide particles and gelatin following storage, there remains a need for further improvement in shelf-life and ease of use of these silver antimicrobial compositions. A number of approaches have been shown to be ineffective following unstirred storage of more than a few days duration. In particular, there remains a need to significantly extend the shelf-life of aqueous silver halide particle and gelatin dispersions such that following warm and unstirred storage conditions of several weeks or months in duration, these dispersions can be redispersed, if necessary, and efficiently and effectively transferred to the end-users equipment.

### SUMMARY OF THE INVENTION

The invention described herein is a new use of adenine in aqueous dispersions of silver halide particles and gelatin. In accordance with the invention, a method is provided for extending the shelf-life of an aqueous dispersion comprising silver halide particles and gelatin, comprises adding adenine to said aqueous dispersion in an amount effective to improve the redispersibility and the colloidal stability of said aqueous dispersion following extended storage. In a particular embodiment, the temperature of the extended storage condition is about 40° C. In a particular embodiment, the silver halide is silver chloride. In various other embodiments, the gelatin is present in an amount less than about 4 weight %, less than about 3 weight %, less than about 2 weight %, or less than about 1 weight %.

The invention also relates to a method of coating fibers, fabrics or substrates with the improved composition to provide antimicrobial properties, and to the coated articles thereof.

### DETAILED DESCRIPTION OF THE INVENTION

It is to be understood that elements not specifically shown or described may take various forms well known to those skilled in the art. The invention is defined by the claims.

The terms “antimicrobial composition” or “composition” used hereafter (infra), refer to the aqueous dispersions comprising silver halide particles, gelatin, and adenine produced by the method of the invention.

In accordance with the invention, a method for extending the shelf-life of an aqueous dispersion of silver halide particles and gelatin, comprises adding adenine to said aqueous dispersion in an amount effective to improve the redispersibility and the colloidal stability thereafter, of said aqueous dispersion following extended storage.

Adenine, also known as Vitamin B₄, is known within the photographic chemistry art for its interaction with silver halide grain surfaces. Its useful function within the photographic art is limited to two narrowly defined uses:
1) Silver halide particle growth modifier. Particle growth modifiers, also termed grain growth modifiers, are employed to alter the size and/or shape of silver halide particles (grains) during the particle formation process. This takes place early in the particle manufacturing process when an aqueous solution of a soluble source of silver ions is combined with a soluble source of halide ions to form supersaturated solutions, typically in the presence of gelatin dispersant. Silver chloride grains typically exhibit a cubic morphology (shape) due to the relative stability of the [100] crystallographic surface. However, adenine may be used to stabilize specifically the [111] crystallographic surface of growing silver chloride particles, thereby promoting the formation of novel tabular shaped particles of silver chloride, as is well described, for example, in U.S. Pat. Nos. 4,400,463; 4,713,323; and 5,252,452.
2) Chemical development inhibitor. The use of adenine as a development inhibitor in lithographic photographic films is for the specific purpose of increasing the photographic contrast, maximizing the optical density and the improving the dot quality of graphic arts images developed therefrom, as is disclosed, for example, in U.S. Pat. No. 5,187,058.

In various embodiments, the composition of the invention comprises water in an amount of at least 50 weight %, at least 80 weight %, or at least 90 weight %; silver halide particles, gelatin and adenine to extend shelf-life.

In various embodiments of the invention, aqueous dispersions of silver halide particles are formed by reacting a soluble source of silver ion, such as silver nitrate, with a soluble source of halide ion, such as an alkali metal halide salt (e.g. sodium chloride, potassium chloride, potassium bromide, potassium iodide), in aqueous solution such that the solubility limit of the various silver halide salts present is exceeded (i.e. a transient state of supersaturation is created) and particle formation via nucleation and growth (i.e. precipitation) occurs. In particular embodiments, gelatin is present during silver halide particle formation to stabilize the surface of the silver halide particles, thereby imparting colloidal stability to the particle dispersion. In various embodiments the halide may be chloride, bromide, or iodide, as well as mixtures of two or more halides. In specific embodiments the silver halide particles are pure silver chloride, silver bromochloride, silver iodochloride, and silver bromoiodochloride. In particular embodiments the silver halide particles are predominantly silver chloride, meaning that the particles are greater than about 50 mole percent silver chloride. In other embodiments, the silver halide particles are greater than about 90 mole percent silver chloride, greater than about 95 mole percent silver chloride, and greater than about 99 mole percent silver chloride. In specific embodiments the silver halide particles contain from 0.1 to 2.0 mole percent iodide, with the balance of the halide as chloride. In other embodiments the silver halide particles are homogeneous in composition, or a core region may be different in composition from a shell region of the particle. In various embodiments, the shape of the silver halide particles is cubic, octahedral or irregular. In specific embodiments the cubic or octahedral shaped silver halide particles have rounded edges or corners. In some embodiments the diameter of the silver halide particles is less than 1 micron, less than 0.5 micron, or less than 0.2 micron.

Methods and agents to reduce discoloration, possibly by the prevention of latent image formation, are also of use in embodiments of the invention. Some silver salts are known to be light sensitive and discolor upon irradiation. However, the degree of light sensitivity may be reduced by several techniques known to those who are skilled in the art. In various embodiments, the silver halide particles of the invention are stored in a low pH environment to minimize discoloration. In general, pH below 7.0 is contemplated, as well as below 4.5. Another technique specifically contemplated to inhibit discoloration involves adding compounds of particular elements, such as, iron, iridium, ruthenium, palladium, osmium, gallium, cobalt, and rhodium, to the silver halide particles. Complexes of these chemical elements are known in the photographic art to change the propensity of latent image formation; and thereby possibly reduce light or thermally induced discoloration of silver halide particles. In particular embodiments, complexes of osmium containing a nitrosyl ligand are incorporated into the silver halide particles. Additional silver halide particle dopants, specifically contemplated, are described in Research Disclosure, February 1995, Volume 370, Item 37038, Section XV.B., published by Kenneth Mason Publications, Ltd., Dudley Annex, 12a North Street, Elmsworth, Hampshire P010 7DQ, England.

Gelatin is a natural polypeptide possessing amphoteric polyelectrolyte character, thereby imparting excellent affinity to a number of substrates. The gelatin used in the practice of this invention may be processed by any of the well-known techniques in the art including: alkali-treatment, acid-treatment, acetylation-treatment, phthalation-treatment or enzyme digestion. In various embodiments, the gelatin has a wide range of molecular weights. In a specific embodiment, low molecular weight gelatins are included, thereby enabling a higher concentration of gelatin in the inventive composition, while avoiding solidifying the composition at ambient temperatures. In particular embodiments, the gelatin in the present invention is added in an amount sufficient to peptize the surface of the silver halide particles, thereby preventing or reducing particle agglomeration and settling. In specific embodiments, gelatin is present during nucleation and growth of the silver halide particles, in other words, during precipitation. In various embodiments, an excess of gelatin beyond the minimum amount needed to peptize the particles is present in the aqueous phase. In particular embodiments, the gelatin is cross-linked in order to improve the durability of an antimicrobial coating. For this purpose, particular embodiments of a process of the invention include a step of adding a gelatin crosslinker, such as alum, formaldehyde and free aldehydes such as glutaraldehyde, bis(iminomethyl)ether salts, s-triazines, or diazines in conventional amounts. In particular embodiments, the gelatin crosslinker is kept separate from the rest of the composition, and is added a short time prior to using the antimicrobial composition in a coating operation.

In various embodiments, any known type of gelatin is used in such an amount whereby the composition does not substantially gel or solidify at 25° C. Particular embodiments that are free-flowing compositions at ambient conditions are able to be efficiently and effectively transferred and possibly mixed with aqueous diluents or other addenda prior to use in an antimicrobial coating operation. Particular embodiments also encompass a more dilute composition that is suitable for dip, pad, or other types of coating. In particular embodiments the composition is substantially free of organic solvents such that use of the composition in textile manufacturing operations does not present an unacceptable explosion hazard in the view of regulatory agencies or other interested parties. In specific embodiments, the composition contains less than about 100 ppm of an organic solvent. In another specific embodiment, no step wherein an organic solvent is intentionally added to the composition is included. In other embodiments, dispersions of the invention contain minor amounts of organic solvents selected by the end-user. In various embodiments the amount of gelatin present is in an amount of at least 0.001 weight %, and less than about 4 weight %, or less than about 3 weight %, or less than about 2 weight %, or less than about 1.3 weight %, or less than about 1 weight %, or less than about 0.7 weight %.

The additive employed in the inventive step, whereby the shelf-life of the antimicrobial composition is extended, is adenine. Adenine (IUPAC name: 9H-purin-6-amine, C₅H₅N₅, CAS No. 73-24-5) is also known by the chemical name 6-aminopurine, or as Vitamin B₄, although it has recently been biochemically reclassified as a DNA metabolite. Taken along with guanine, it is considered to be a purine base of nucleic acids. Adenine is characterized by a pKₐ of about 4.2. The chemical structure of adenine is shown below:

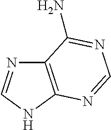

In an embodiment of the instant invention, adenine is present in an amount effective to improve the redispersibility and the colloidal stability thereafter of the aqueous dispersions comprising silver halide particles and gelatin, following extended storage. In particular embodiments, the molar ratio of adenine to silver halide ranges from about 0.015 to about 0.06. In other particular embodiments, adenine is dissolved in water at an alkaline pH of about 12.5, then the pH of this solution is adjusted to about 4-5, after which the solution is added to the aqueous dispersion of silver halide particles and gelatin. In a specific embodiment, the pH of the adenine containing solution is adjusted to about 4.3.

In addition to gelatin, particular embodiments include minor amounts of a hydrophobic binder resin in the composition to improve the adhesion and durability of the silver halide particles once applied to a fiber, fabric, or substrate surface. Such hydrophobic binders are well known in the art and are typically provided as aqueous suspensions of polymer microparticles. In various embodiments, the hydrophobic binders are acrylic, styrene-butadiene, polyurethane, polyester, polyvinyl acetate, polyvinyl acetal, vinyl chloride and vinylidine chloride polymers, including copolymers and combinations thereof. In particular embodiments, the concentration of such hydrophobic binders is less than about 5 weight %.

In various other embodiments, optional components are also present, for example, thickeners or wetting agents in the composition, to aid in the application of the composition to a substrate. Examples of wetting materials include surface active agents commonly used in the art such as ethyleneoxide-propyleneoxide block copolymers, polyoxyethylene alkyl phenols, polyoxyethylene alkyl ethers, and the like. Compounds useful as thickeners include, for example, particulates such as silica gels and smectite clays, polysaccharides such as xanthan gum, polymeric materials such as acrylic-acrylic acid copolymers, hydrophobically modified ethoxylated urethanes, hydrophobically modified nonionic polyols, and hydroxypropyl methylcellulose.

In various embodiments, the composition of this invention is applied to a desired substrate using any known method in art, including, but not limited to, pad coating, knife coating, screen coating, spraying, foaming, and kiss-coating. In a particular embodiment, the components of the inventive composition are delivered in a single dispersion. In other embodiments, components of the inventive composition are delivered in a plurality of dispersions. In a particular embodiment, components of the inventive composition are delivered as a separately packaged two-part system, wherein the silver halide particles, gelatin, adenine, and water comprise a first dispersion—Part A, and any optional hydrophobic binders, additional hydrophilic binders, or chemically compatible polymer cross-linking agents comprise a second dispersion—Part B. Part A has improved shelf-life with regard to redispersibility and colloidal stability following extended storage at ambient temperatures without stirring or agitation. In a particular embodiment, the two parts are combined a short time prior to a textile padding or coating operation, and the combination exhibits colloidal stability for the useful life of the combined composition, typically on the order of hours to days.

In various embodiments, the composition of this invention is applied to any particular substrate (such as polymeric films, papers, or metal foils or other objects) and is not limited in its use. In particular embodiments, application to fibers, textile fabric, or yarn, including by an exhaustion process, to any natural or manufactured fibers, is specifically contemplated. In particular embodiments, examples of natural fibers include, cotton (cellulosic), wool, or other natural hair fibers, such as mohair and angora. In other embodiments, application to manufactured synthetic fibers, including, for example, polyester, polyethylene, polypropylene, nylon, acrylic, polyamide, or, regenerated materials such as cellulosics. In particular embodiments, the target fiber or yarn includes any number of chemistries or applications prior to, during or after the application of the antimicrobial composition of the invention including, for example, antistatic control agents, flame retardants, soil resistant agents, wrinkle resistant agents, shrink resistant agents, dyes and colorants, brightening agents, UV stabilizers, lubricants, or antimigrants. The invention is further illustrated by the following examples, which are not intended to limit the invention in any manner.

### EXPERIMENTAL SECTION

### Preparation of Aqueous Silver Chloride Particle Dispersion

Silver chloride particles (grains) were prepared according to the following process:

In a 5 liter reactor, 1.623 liters of water was added with 32.5 grams of inert photographic gelatin. After the gelatin was allowed to soak for 30 minutes at room temperature, it was heated to 40° C. and allowed to dissolve with stirring. The gelatin solution was then heated to 46° C., and 3.75 grams of NaCl was added and allowed to dissolve. 3 Molar aqueous solutions of AgNO₃ and NaCl were added to the reactor through jets directed into the impeller blades at 46.5 ml/minute each for 17 minutes, 55 seconds. The chloride concentration was maintained via a silver/silver chloride electrode with a feedback loop controlling the NaCl delivery rate. Upon completion of the AgNO₃ and NaCl delivery, the dispersion was allowed to ripen at 46° C. for 5 minutes before cooling to 35° C. The dispersion was washed by ultra-filtration to a conductivity of under 10 mS/cm. The dispersion was then diluted with water to a composition of about 3 weight % silver and about 0.6 weight % gelatin. This aqueous dispersion of preformed silver chloride particles in gelatin was used to evaluate a variety of stabilizers under extended storage conditions as described below.

The silver chloride particles formed by the procedures described above were examined by transmission electron microscopy (SEM), analysis of which indicated that the particles displayed a cubic morphology characterized by a 0.16-0.18 micron edge length.

### Preparation of Stabilized Dispersions

### Example 1

### No Stabilizer (Comparative)

A 100 gram portion of the aqueous preformed silver chloride particle and gelatin dispersion described above was heated to 40° C. with stirring, the pH was adjusted to 4.3, and stirred an additional 5 minutes at 40° C.

### Example 2

### Uric Acid (Comparative)

A 0.055 gram quantity of uric acid was dissolved in high purity water along with the addition of several drops of a NaOH solution to make a final volume of 42.2 milliliters (ml). This solution of uric acid was then added to a 75 gram portion of the aqueous preformed silver chloride particle and gelatin dispersion described above, which had been heated to 40° C. with stirring. The pH of this stabilized dispersion was adjusted to 4.3, and stirred an additional 5 minutes at 40° C.

### Example 3

### Saccharin (Comparative)

A 0.055 gram quantity of saccharin was dissolved in high purity water along with the addition of several drops of a NaOH solution to make a final volume of 6.3 ml. This solution of saccharin was then added to a 100 gram portion of the aqueous preformed silver chloride particle and gelatin dispersion described above, which had been heated to 40° C. with stirring. The pH of this stabilized dispersion was adjusted to 4.3, and stirred an additional 5 minutes at 40° C.

### Example 4

### Adenine 1× Concentration, Low pH (Inventive)

A 0.058 gram quantity of adenine was dissolved in high purity water that had been adjusted to a pH of 12.5. Thereafter, this stabilizer solution was adjusted to a pH of 4.3 with nitric acid, to make a final solution volume of 6.2 ml. This solution of adenine was then added to a 100 gram portion of the aqueous preformed silver chloride particle and gelatin dispersion described above, which had been heated to 40° C. with stirring. The pH of this stabilized dispersion was adjusted to 4.3, and stirred an additional 5 minutes at 40° C.

### Example 5

### Adenine 1× Concentration, High pH (Comparative)

A 0.058 gram quantity of adenine was dissolved in high purity water that had been adjusted to a pH of 12.5, to make a final solution volume of 6.2 ml. This high pH solution of adenine was then added to a 100 gram portion of the aqueous preformed silver chloride particle and gelatin dispersion described above, which had been heated to 40° C. with stirring. The pH of this stabilized dispersion was adjusted to 4.3, and stirred an additional 5 minutes at 40° C.

### Example 6

### Adenine 4× Concentration, Low pH (Inventive)

A 0.197 gram quantity of adenine was dissolved in high purity water that had been adjusted to a pH of 12.5. Thereafter, this stabilizer solution was adjusted to a pH of 4.3 with nitric acid, to make a final solution volume of 21.2 ml. This solution of adenine was then added to an 85 gram portion of the aqueous preformed silver chloride particle and gelatin dispersion described above, which had been heated to 40° C. with stirring. The pH of this stabilized dispersion was adjusted to 4.3, and stirred an additional 5 minutes at 40° C.

### Example 7

### Adenine 4× Concentration, High pH (Comparative)

A 0.197 gram quantity of adenine was dissolved in high purity water that had been adjusted to a pH of 12.5, to make a final solution volume of 21.2 ml. This high pH solution of adenine was then added to a 100 gram portion of the aqueous preformed silver chloride particle and gelatin dispersion described above, which had been heated to 40° C. with stirring. The pH of this stabilized dispersion was adjusted to 4.3, and stirred an additional 5 minutes at 40° C.

### Storage, Redispersal and Stability Testing Protocols:

Dispersion samples prepared as described above in Examples 1-7 were transferred to a 40° C. oven and stored in an unstirred and un-agitated state. After a storage period of 5 days, samples of each of the dispersions were removed from the oven and redispersed at 40° C. by stirring for 20 minutes. The stirring was haulted, and the dispersions maintained at 40° C. without stirring for 30 minutes. Thereafter the colloidal stability (settling) of the redispersed samples was visually assessed according to the following procedure:

1. The dispersion was slowly poured from the container to another container.

2. The uniformity and consistency of the dispersion was noted from the beginning of the pour to the end.

3. The degree of settling was characterized as follows:
No Settling: dispersion was uniform throughout the pour, no phase separation was observed, no clumping in the dispersion was observed, and the bottom of the container was substantially clear of settled particles.
Minor Settling: dispersion poured as described above, except that a slight amount of phase separation was noted at the end of the pour, and the bottom of the container had some settled particles.
Moderate Settling: dispersion poured as described above, except that a moderate amount of phase separation was noted at the end of the pour.
Significant Settling: clumping was clearly observed during the pour, and a significant amount of phase separation was noted at the end of the pour.

In addition, the degree of phase separation for some the redispersed samples was quantitatively assessed by drawing a sample from the top of the container before and after the 30 minute settling period that followed redispersal, and measuring the silver content of these drawn samples by atomic absorption (AA) analysis. The degree of settling is reported as the percent decrease in silver content at the end of the 30 minute settling period relative to the start. More specifically, Percent Settle is defined by the expression [(Silver Assay (start)−Silver Assay (end))/Silver Assay (start)]×100, such that a Percent Settle of zero represents the idea result wherein the silver remains homogeneously distributed within the dispersion (i.e. stable) such that no phase separation occurs during the settling period.

Colloidal stability test results for the 5 day unstirred storage period at 40° C. are given in Table 1 below.

TABLE 1
Colloidal Stability Results: 5 Days Unstirred Storage at 40° C.

| | | Visual | |
|---|---|---|---|
| Example | Stabilizer | Assessment | Comment |
| 1 | None | Moderate Settling | Comparative |
| 2 | Uric Acid | Minor Settling | Comparative |
| 3 | Saccharin | Significant Settling | Comparative |
| 4 | Adenine 1X, Low pH | No Settling | Inventive |
| 5 | Adenine 1X, High pH | Significant Settling | Comparative |
| 6 | Adenine 4X, Low pH | Moderate Settling | Inventive |
| 7 | Adenine 4X, High pH | Significant Settling | Comparative |

Comparison of the results shown above for Example 4 to Examples 1-3 indicates that the use of adenine at the 1× amount provides substantial improvement in colloidal stability during the 30 minute settling period following redispersal, relative to each of unstabilized comparative Example 1, uric acid stabilized comparative Example 2 and saccharin stabilized comparative Example 3. Comparison of the results among Examples 4-7 indicates that the inventive new use of adenine requires the additional inventive step of adjusting the pH of the original adenine stabilizer solution to low pH before addition to the preformed silver halide particle and gelatin dispersion. Use of adenine at the 1× amount is preferred relative to the 4× amount.

While the invention has been described by reference to various specific embodiments, it should be understood that numerous changes may be made within the spirit and scope of the inventive concepts described. Accordingly, it is intended that the invention not be limited to the described embodiments, but will have full scope defined by the claims.

What is claimed:

1. A method for extending the shelf-life of an aqueous dispersion comprising silver halide particles and gelatin, comprising the step:
adding adenine to said aqueous dispersion in an amount effective to improve the redispersibility and the colloidal stability thereafter of said aqueous dispersion following extended storage.

2. The method of claim 1, wherein said adenine is predispersed in an alkaline aqueous solution.

3. The method of claim 2, wherein the alkaline aqueous solution is characterized by a pH of about 12.5.

4. The method of claim 2, further comprising the step of reducing the pH of said alkaline aqueous solution to a pH value less than 7.

5. The method of claim 4, wherein said pH value is about 4-5.

6. The method of claim 1, wherein said silver halide particles comprise silver chloride.

7. The method of claim 6, wherein said silver halide particles are predominantly silver chloride.

8. The method of claim 6, wherein said silver halide particles are characterized by substantially cubic particle morphology and an edge length less than about 0.2 microns.

9. The method of claim 1, wherein said gelatin is present in an amount less than about 2 weight percent.

10. The method of claim 1, wherein said storage comprises temperatures less than about 40° C.

11. The method of claim 1, wherein said extended storage comprises storage times greater than or equal to 5 days.

12. The method of claim 1, wherein said adenine is present in a molar amount less than about 0.06 relative to the molar amount of silver halide.

13. An antimicrobial composition comprising at least 50 weight percent of water, silver halide particles, adenine, and gelatin in an amount less than about 1.3 weight percent.

14. A fiber, fabric or substrate comprising a dried antimicrobial coating provided from the composition of claim 13.
